(19) United States
(12) Patent Application Publication
(10) Pub. No.: US 2024/0348739 A1
(43) Pub. Date: Oct. 17, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kazuko KIRIHARA, Kanagawa (JP)

(73) Assignee: FUJIFILM Business Innovation Corp., Tokyo (JP)

(21) Appl. No.: 18/488,203

(22) Filed: Oct. 17, 2023

(30) Foreign Application Priority Data
Apr. 11, 2023 (JP) 2023-064324

(51) Int. Cl. H04N 1/44; G06F 21/84

(52) U.S. Cl. CPC H04N 1/4406; G06F 21/84

(57) ABSTRACT

An information processing system includes: one or multiple processors configured to, upon a determination that an event which has occurred in an image processing apparatus with an operation screen in a hidden state due to remote control is to be notified to a second user to whom the operation screen is visible, display, on the operation screen, notification information including a message indicating that the event has occurred, the remote control being in operation via a terminal by a first user.

### CROSS-REFERENCE TO RELATED APPLICATIONS

This application is based on and claims priority under 35 USC 119 from Japanese Patent Application No. 2023-064324 filed Apr. 11, 2023.

### BACKGROUND

### (i) Technical Field

The present disclosure relates to an information processing system, a non-transitory computer readable medium, and an information processing method.

### (ii) Related Art

A technique is known which enables remote control of an image processing apparatus such as so-called MFP from a mobile terminal, the MFP being capable of printing and reading of a document. In such a technique, the operation screen of the image processing apparatus is shared by the mobile terminal, thus operation contents for the operation screen of the mobile terminal may be visible to a user around the image processing apparatus. In contrast, from the point of view of information security, a technique of hiding the operation screen of the image processing apparatus has also been proposed (for example, Japanese Unexamined Patent Application Publication No. 2019-16349).

### SUMMARY

However, even when the operation screen of the image processing apparatus remote controlled via a terminal of a user is in a hidden state, for example, the user may desire to notify a user around the image processing apparatus of an occurrence of an error on the system, or desire a user around the image processing apparatus to cope with a situation such as so-called “out of paper”.

Aspects of non-limiting embodiments of the present disclosure relate to an information processing system capable of notifying another user around an image processing apparatus of information even in a hidden state of the operation screen of the image processing apparatus which is remote controlled via a terminal of a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to, upon a determination that an event which has occurred in an image processing apparatus with an operation screen in a hidden state due to remote control is to be notified to a second user to whom the operation screen is visible, display, on the operation screen, notification information including a message indicating that the event has occurred, the remote control being in operation via a terminal by a first user.

### BRIEF DESCRIPTION OF THE DRAWINGS

Exemplary embodiment of the present disclosure will be described in detail based on the following figures, wherein:

FIG. 1 is a view illustrating an example of the entire configuration of an information processing system to which the exemplary embodiment is applied;

FIG. 2 is a diagram illustrating an example of the hardware configuration of an image processing apparatus;

FIG. 3 is a diagram illustrating an example of the functional configuration of a controller of the image processing apparatus;

FIG. 4 is a diagram illustrating an example of the functional configuration of a controller of a remote terminal;

FIGS. 5A and 5B are flowcharts illustrating an example of a process flow of the image processing apparatus;

FIGS. 6A and 6B are views illustrating specific examples of information displayed on the image processing apparatus and the remote terminal, FIG. 6A is a view illustrating a specific example of information displayed on the image processing apparatus, and FIG. 6B is a view illustrating a specific example of information displayed on the remote terminal;

FIGS. 7A and 7B are views illustrating specific examples of information displayed on each of the image processing apparatus and the remote terminal when restrictions on the operation to the operation screen of the image processing apparatus are released, FIG. 7A is a view illustrating a specific example of information displayed on the image processing apparatus when restrictions on the operation to the operation screen of the image processing apparatus are released, and FIG. 7B is a view illustrating a specific example of information displayed on the screen of the remote terminal when restrictions on the operation to the image processing apparatus are released;

FIG. 8 is a view illustrating a specific example of information displayed on the operation screen in a hidden state; and

FIG. 9 is a table illustrating a specific example of setting release ranges when there is a plurality of users who specify the release ranges for restrictions on the operation.

### DETAILED DESCRIPTION

Hereinafter, an exemplary embodiment of the present disclosure will be described in detail with reference to the accompanying drawings.

### <Configuration of Information Processing System>

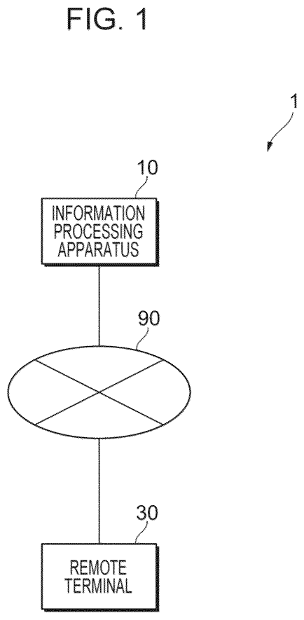

FIG. 1 is a view illustrating an example of the entire configuration of an information processing system 1 to which the exemplary embodiment is applied.

The information processing system 1 is constituted by connecting an image processing apparatus 10 and a remote terminal 30 via a network 90. The network 90 is, for example, a local area network (LAN), and the Internet.

### (Image Processing Apparatus)

The image processing apparatus 10 performs various processes according to an input operation of a user who utilizes the information processing system 1. For example, the image processing apparatus 10 performs a process of forming an image on a medium such as paper, a process of outputting a recording medium on which an image is formed, and a process of reading an image formed on paper or the like. As the image processing apparatus 10, for example, a so-called electrophotographic MFP that forms a toner image on the printing surface of paper, and a so-called inkjet printer that ejects ink onto the printing surface of paper may be mentioned.

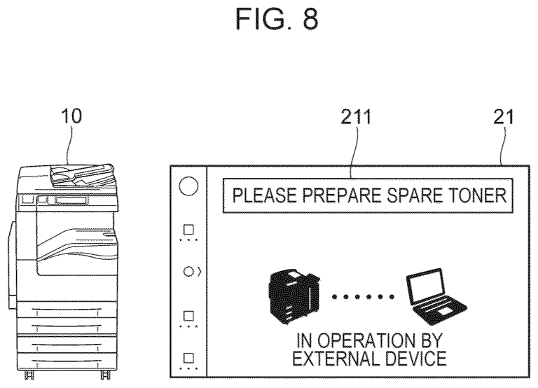

The image processing apparatus 10 obtains various information transmitted from the remote terminal 30, and performs various processes. The image processing apparatus 10 also transmits various information to the remote terminal 30. For example, in a hidden state of the operation screen of the image processing apparatus 10 due to remote control via the remote terminal 30 operated by a first user, when an event to be notified to a second user occurs to whom the operation screen of the image processing apparatus 10 is visible, the image processing apparatus 10 displays, on the operation screen in the hidden state, notification information including a message indicating the occurrence of the event. A specific example of a display state of notification information on the operation screen in the hidden state will be described below with reference to FIG. 8.

Here, the “hidden state” of the operation screen refers to the state in which another screen which serves as a mask is superimposed on the operation screen. When the operation screen is in the hidden state as mentioned above, the second user around the image processing apparatus 10 cannot operate the image processing apparatus 10. The “event to be notified to the second user” is, for example, a system error (e.g., insufficient memory, application software abnormality detected), and an event (e.g., out of paper, replacement of a toner cartridge) which needs support by the second user. In addition, the “notification information” includes, for example, a message indicating the occurrence of a system error, and a message requesting support by the second user.

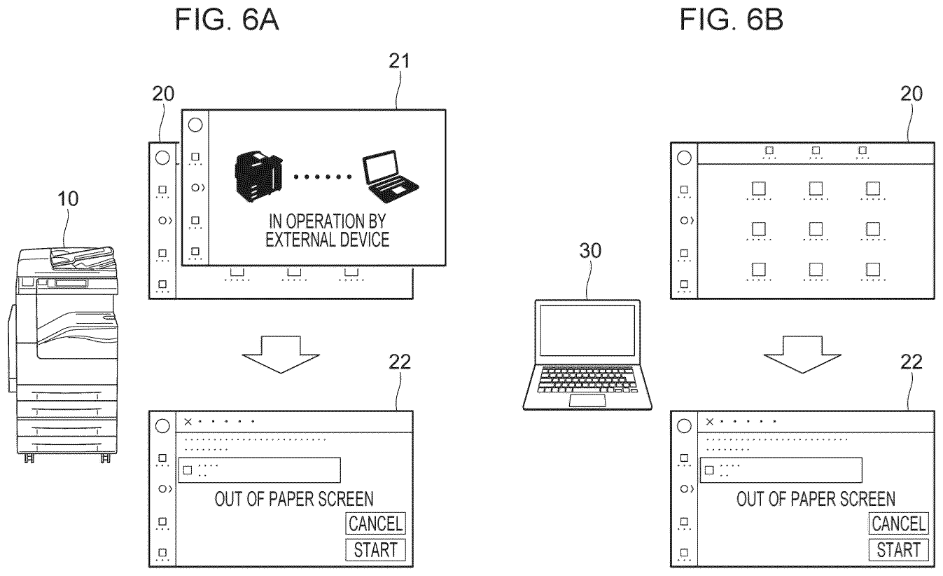

When the image processing apparatus 10 displays notification information on the operation screen thereof, the image processing apparatus 10 may release the hidden state of the operation screen. For example, when the event to be notified to the second user is an event (e.g., a system error) which requires restart of the image processing apparatus 10, the image processing apparatus 10 releases the hidden state of the operation screen before restarting the image processing apparatus 10. A specific example of the operation screen with the hidden state released will be described below with reference to FIGS. 6A and 6B.

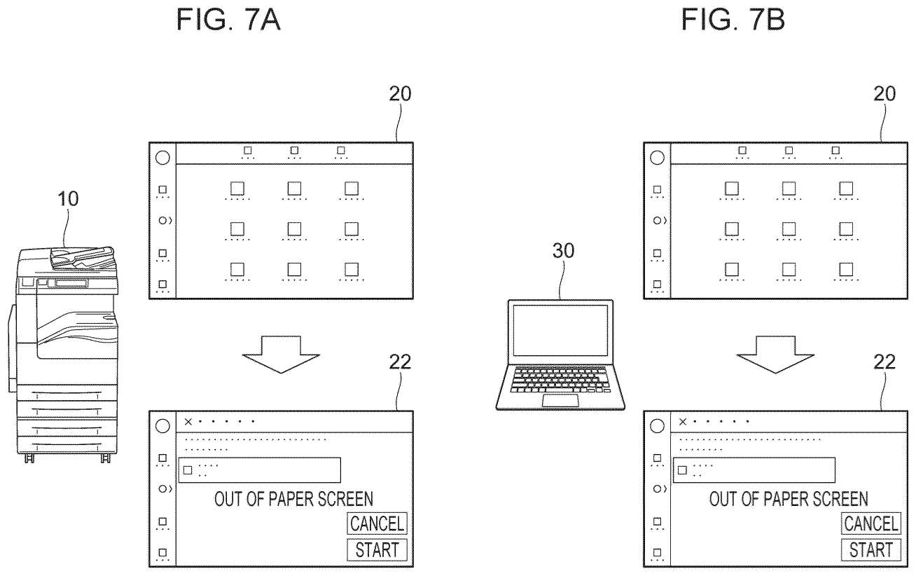

When the image processing apparatus 10 release the hidden state of the operation screen thereof, if restrictions are imposed on the operation to the operation screen, the image processing apparatus 10 may release part or all of the restrictions. Specifically, even when the hidden state of the operation screen of the image processing apparatus 10 is released, and the operation screen is visible to the second user, direct operation to the operation screen itself may be restricted. In such a case, the image processing apparatus 10 releases not only the hidden state of the operation screen, but also part or all of the restrictions. A specific example of the operation screen in which restrictions on the operation are released will be described below with reference to FIGS. 7A and 7B.

When the image processing apparatus 10 releases the hidden state of the operation screen thereof, and the restrictions on the direct operation to the operation screen, the restrictions are released according to a preset release range. The manner how to set a release range is not particularly limited. For example, the image processing apparatus 10 may set a release range based on a pre-specified release range.

In this case, when a single user specifies a release range for restrictions on the operation to the operation screen, the image processing apparatus 10 may set the specified release range as the actual release range, and when a plurality of users specify release ranges, the image processing apparatus 10 may set the narrowest one among the specified release ranges as the actual release range. For example, when each of the administrator of the image processing apparatus 10 and the first user specifies a release range, the image processing apparatus 10 sets the narrower one between the specified release ranges as the actual release range.

When an event to be notified to the second user occurs, in order to resolve the event, the image processing apparatus 10 may set a release range according to the contents to be performed by the second user. In this case, the image processing apparatus 10 may set a release range for each type of an event to be notified to the second user. Specifically, for example, an event corresponding to a system error, and an event which is not a system error but requires support by the second user are managed as different types, and a release range may be set for each type.

The image processing apparatus 10 returns the operation screen thereof with the hidden state released to the hidden state again at a predetermined timing. For example, the image processing apparatus 10 returns the operation screen thereof to the hidden state again at a timing when an event to be notified to the second user is dissolved, or at a timing when an input operation to delete display of notification information is performed. For example, the image processing apparatus 10 returns the operation screen thereof to the hidden state again at a timing when a predetermined operation is performed to the operation screen of the image processing apparatus 10. The details of the processes performed by the image processing apparatus 10 will be described below.

### (Remote Terminal)

The remote terminal 30 is a mobile information processing device, such as a smartphone, and a tablet terminal, operated by a user who utilizes the information processing system 1. Application software to enable operation of the image processing apparatus 10 is installed in the remote terminal 30. The remote terminal 30 obtains various information transmitted from the image processing apparatus 10, and performs various processes. The remote terminal 30 transmits various information to the image processing apparatus 10. For example, the remote terminal 30 receives an input operation to specify a release range for restrictions on the operation, and transmits the input information to the image processing apparatus 10. The details of the processes performed by the remote terminal 30 will be described below.

The above-described configuration of the information processing system 1 is an example, and may have functions to implement the above-described processes by the information processing system 1 in its entirety. Thus, part or all of the functions to implement the above-described processes may be shared or may be collaborated in the information processing system 1. In other words, part or all of the functions of the remote terminal 30 may be the functions of the image processing apparatus 10, or part or all of the functions of the image processing apparatus 10 may be the functions of the remote terminal 30. In addition, part or all of the functions of each of the remote terminal 30 and the image processing apparatus 10 included in the information processing system 1 may be transferred to another server which is not illustrated. Consequently, the processes as the information processing system 1 in its entirety are promoted, or the processes can be supplemented to each other.

### (Hardware Configuration of Image Processing Apparatus)

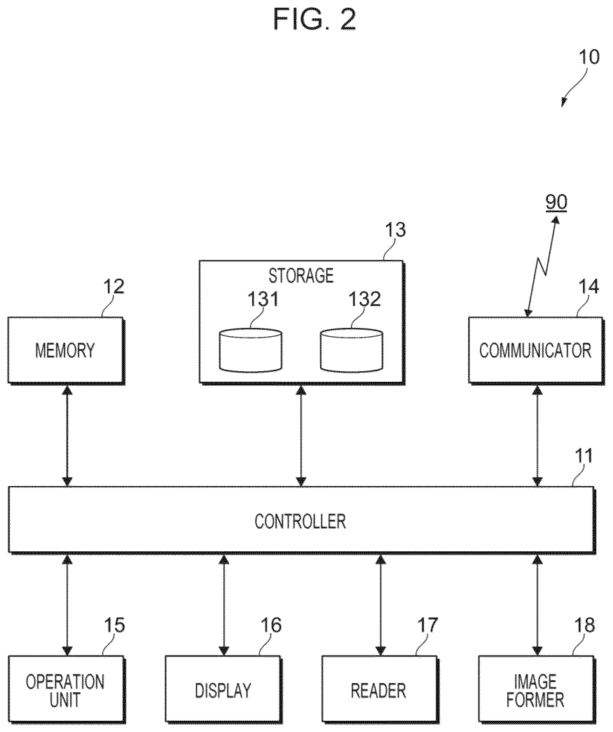

FIG. 2 is a diagram illustrating an example of the hardware configuration of the image processing apparatus 10.

The image processing apparatus 10 includes a controller 11, a memory 12, a storage 13, a communicator 14, an operation unit 15, a display 16, a reader 17, and an image former 18. These components are connected via a data bus, an address bus, or a peripheral component interconnect (PCI) bus.

The controller 11 is a processor that controls the function of the remote terminal 30 through execution of OS (basic software) or various software such as application software (applied software). The controller 11 is constituted by, for example, a central processing unit (CPU). The memory 12 is a storage area that stores various software and data to be used for executing the various software, and is used as a work area for calculation. The memory 12 is constituted by, for example, a random access memory (RAM).

The storage 13 is a storage area that stores input data to various software and output data from various software. The storage 13 is constituted by, for example, a hard disk drive (HDD), a solid state drive (SSD), and a semiconductor memory which are used to store programs and various setting data. As databases to store various information, the storage 13 stores, for example, setting DB131 that stores various setting information including information related to setting of a release range for restrictions on the operation of the second user, and screen DB132 that stores screens such as an operation screen and a mask screen.

The communicator 14 transmits and receives data between the remote terminal 30 and the outside via the network 90. The operation unit 15 includes, for example, a software keyboard, mechanical buttons, switches, and receives an input operation. The operation unit 15 also includes a touch sensor that constitutes a touch panel integrally with the display 16. The display 16 is constituted by, for example, a liquid crystal display or an organic electro luminescent (EL) display which is used to display information, and the display 16 displays data of image and text.

The reader 17 reads an image recorded on a medium (e.g., a paper medium document) such as paper serving as a recording medium. The reader 17 is constituted by, for example, a charge coupled device (CCD) scanner that emits light from a light source to a document and reduces reflection light by a lens to receive the light by a CCD, and a contact image sensor (CIS) scanner that emits light sequentially from an LED light source to a document, and receives reflection light by a CIS. The image former 18 forms an image to be printed on the printing surface of paper as a recording medium, for example, by an electrophotographic system or an ink jet system. These components are connected via a data bus, an address bus, or a PCI bus.

### (Hardware Configuration of Remote Terminal)

The hardware configuration of the remote terminal 30 includes the same components as those of the hardware configuration of the image processing apparatus 10 illustrated in FIG. 2 excluding the reader 17 and the image former 18. Specifically, the remote terminal 30 includes a controller, a memory, a storage, a communicator, an operation unit, and a display which have the same functions as those of the controller 11, the memory 12, the storage 13, the communicator 14, the operation unit 15, and the display 16 in FIG. 2, thus illustration and a description are omitted.

### (Functional Configuration of Controller of Image Processing Apparatus)

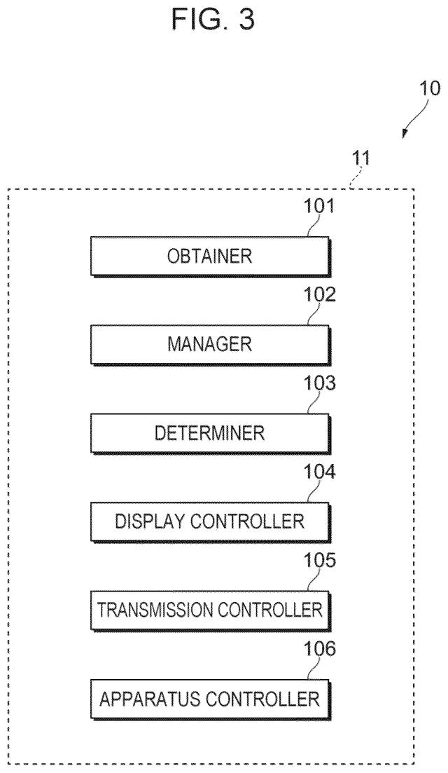

FIG. 3 is a diagram illustrating an example of the functional configuration of the controller 11 of the image processing apparatus 10.

An obtainer 101, a manager 102, a determiner 103, a display controller 104, a transmission controller 105, and an apparatus controller 106 function in the controller 11 of the image processing apparatus 10.

The obtainer 101 obtains various information. For example, the obtainer 101 obtains various information transmitted from each of the remote terminal 30 and the outside. As the information transmitted from the remote terminal 30 among the information obtained by the obtainer 101, for example, input information inputted by an operation of the first user may be mentioned. As the input information obtained by the obtainer 101, for example, the information inputted by the first user to specify a release range for restrictions on the operation may be mentioned. The obtainer 101 obtains the input information received by the operation unit 15 (see FIG. 2).

The manager 102 stores and manages various information in a database of the storage 13 (see FIG. 2). For example, the manager 102 stores and manages various setting information in the setting DB131, the various setting information including information related to setting of a release range for restrictions on the operation of the second user. The manager 102 stores and manages screens such as an operation screen and a mask screen in the screen DB132.

The determiner 103 determines whether the operation screen of the image processing apparatus 10 is in the hidden state due to remote control via the remote terminal 30 operated by the first user. The determiner 103 determines whether an event to be notified to the second user has occurred to whom the operation screen of the image processing apparatus 10 is visible. When determining that an event to be notified to the second user has occurred to whom the operation screen of the image processing apparatus 10 is visible, the determiner 103 further determines the type of the event. Specifically, the determiner 103 determines whether the event to be notified to the second user is an event (e.g., a system error) which requires restart of the image processing apparatus 10, or an event which does not require restart, but requires support by the second user.

The display controller 104 performs control to cause the display 16 (see FIG. 2) to display various information. For example, when the operation screen of the image processing apparatus 10 is in the hidden state and an event to be notified to the second user has occurred to whom the operation screen of the image processing apparatus 10 is visible as a result of determination by the determiner 103, the display controller 104 displays notification information on the operation screen of the image processing apparatus 10.

The display controller 104 performs control to display a mask screen which is superimposed on the operation screen in order to achieve the hidden state of the operation screen of the image processing apparatus 10, and performs control to set a mask screen to non-display, the mask screen being displayed so as to be superimposed on the operation screen. For example, when the event to be notified to the second user is an event (e.g., a system error) which requires restart of the image processing apparatus 10 as a determination result of the determiner 103, the display controller 104 performs control to set a mask screen to non-display, before the image processing apparatus 10 is restarted, the mask screen causing the operation screen of the image processing apparatus 10 to be in the hidden state.

The display controller 104 performs control to cause the mask screen in a non-display state to be displayed again at a predetermined timing. For example, the display controller 104 performs control to cause the mask screen in a non-display state to be displayed again at a timing when the event to be notified to the second user is dissolved, or at a timing when an input operation to delete display of notification information is performed. For example, the display controller 104 performs control to cause the mask screen in a non-display state to be displayed again at a timing when a predetermined operation is performed on the operation screen of the image processing apparatus 10.

The transmission controller 105 performs control to transmit various information. Specifically, the transmission controller 105 performs control to transmit various information to each of the remote terminal 30 and the outside. The information transmitted to the remote terminal 30 among the information whose transmission is controlled by the transmission controller 105 is, for example, data of the operation screen of the image processing apparatus 10 to be shared to perform remote control.

The apparatus controller 106 performs control to restrict the operation to the operation screen of the image processing apparatus 10. For example, when remote control of the image processing apparatus 10 is in operation, the apparatus controller 106 performs control for restriction so that the operation unit 15 does not receive an operation by the second user. Furthermore, when an event to be notified to the second user has occurred during restrictions on the operation of the second user, and the event requires restart of the image processing apparatus 10, the apparatus controller 106 performs control to release the restrictions according to a preset release range, and subsequently, performs control to restart the image processing apparatus 10.

### (Functional Configuration of Controller of Remote Terminal)

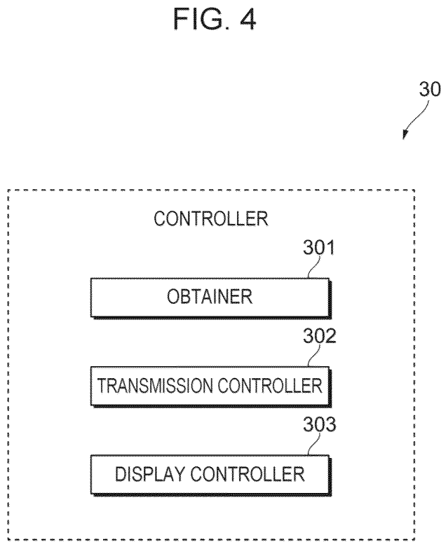

FIG. 4 is a diagram illustrating an example of the functional configuration of the controller of the remote terminal 30.

An obtainer 301, a transmission controller 302, and a display controller 303 function in the controller of the remote terminal 30.

The obtainer 301 obtains various information. Specifically, the obtainer 301 obtains various information transmitted from the image processing apparatus 10 and the outside. The information transmitted from the image processing apparatus 10 among the information obtained by the obtainer 301 is, for example, data of the operation screen of the image processing apparatus 10 to be shared to perform remote control. The obtainer 301 obtains input information on the operation received by the operation unit. For example, the obtainer 301 obtains information inputted to specify a release range for restrictions on the operation.

The transmission controller 302 performs control to transmit various information via the communicator. Specifically, the transmission controller 302 performs control to transmit various information to the image processing apparatus 10 and the outside. The information transmitted to the image processing apparatus 10 among the information whose transmission is controlled by the transmission controller 302 is, for example, the information inputted to specify a release range for restrictions on the operation.

The display controller 303 performs control to cause the display to display various information. For example, the display controller 303 performs control to display, on the display, the operation screen of the image processing apparatus 10 to be shared to perform remote control.

### <Process Flow>

### (Process Flow of Image Processing Apparatus)

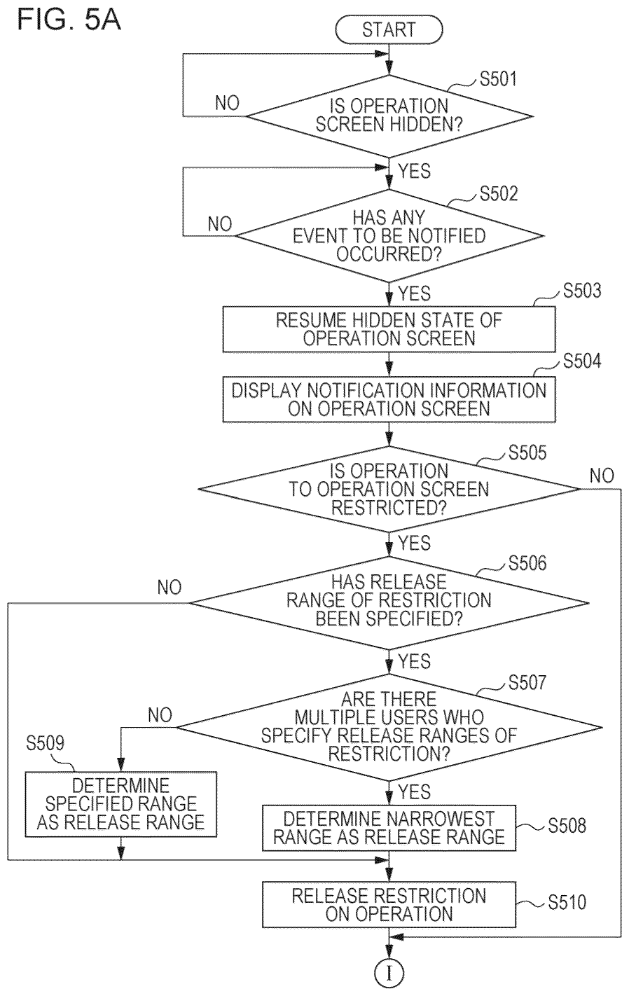

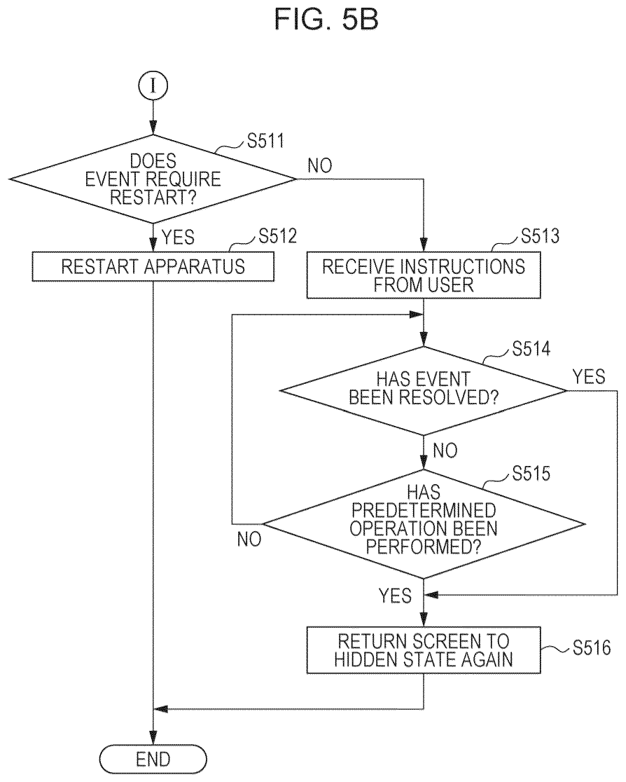

FIGS. 5A and 5B are flowcharts illustrating an example of a process flow of the image processing apparatus 10.

When the operation screen is hidden (YES in step 501) due to remote control in operation via a terminal by the first user, if an event to be notified to the second user occurs to whom the operation screen is visible (YES in step 502), the image processing apparatus 10 proceeds to step 503. In contrast, when the operation screen is not hidden (NO in step 501), the determination process in step 501 is repeated until the operation screen achieves the hidden state. When an event to be notified to the second user has not occurred (NO in step 502), the image processing apparatus 10 repeats the determination process in step 502 until an event to be notified to the second user occurs.

The image processing apparatus 10 releases the hidden state of the operation screen (step 503), and displays, on the operation screen, notification information including a message indicating the occurrence of an event (step 504), and proceeds to the determination process in step 505.

When restrictions are imposed on the operation to the operation screen (YES in step 505) and a release range for restrictions on the operation to the operation screen is specified (YES in step 506), the image processing apparatus 10 proceeds to the determination process in step 507. In contrast, when no restrictions are imposed on the operation to the operation screen (NO in step 505), the image processing apparatus 10 proceeds to the determination process in step 511. When a release range for restrictions on the operation to the operation screen is not specified (NO in step 506), the image processing apparatus 10 releases the restrictions on the operation to the operation screen (step 510), and proceeds to the determination process in step 511.

When a plurality of users specify release ranges for restrictions on the operation to the operation screen (YES in step 507), the image processing apparatus 10 determines the narrowest one among the specified release ranges as the release range (step 508), and releases the restrictions on the operation (step 510). In contrast, when a single user specifies a release range for restrictions on the operation to the operation screen (NO in step 507), the image processing apparatus 10 determines the specified range as the release range (step 509), and releases the restrictions on the operation (step 510). The image processing apparatus 10 proceeds to the determination process in step 511.

When the event to be notified to the second user is an event which requires restart of the image processing apparatus 10 (YES in step 511), the image processing apparatus 10 restarts itself (step 512). In contrast, when the event to be notified to the second user is an event which does not require restart of the image processing apparatus 10 (NO in step 511), the image processing apparatus 10 receives instructions from a user (step 513), and proceeds to the determination process in step 514.

When the event to be notified to the second user is dissolved (YES in step 514), the image processing apparatus 10 returns the operation screen with the hidden state released to the hidden state again (step 516). In contrast, when the event to be notified to the second user is not dissolved (NO in step 514), if a predetermined operation is performed (YES in step 515), the image processing apparatus 10 returns the screen to the hidden state again (step 516). The “predetermined operation” refers to, for example, an operation to delete display of notification information, an operation to release the hidden state, and a predetermined operation to the operation screen. In contrast, when a predetermined operation is not performed (NO in step 515), the image processing apparatus 10 returns to the determination process in step 514.

### Specific Examples

FIGS. 6A and 6B are views illustrating specific examples of information displayed on the image processing apparatus 10 and the remote terminal 30. FIG. 6A is a view illustrating a specific example of information displayed on the image processing apparatus 10. FIG. 6B is a view illustrating a specific example of information displayed on the remote terminal 30.

When the operation screen 20 of the image processing apparatus 10 is shared between the image processing apparatus 10 and the remote terminal 30 due to remote control from the remote terminal 30, a mask screen 21 to hide the operation screen 20 is displayed so as to be superimposed on the operation screen 20 in the image processing apparatus 10. FIG. 6A illustrates a screen displaying “IN OPERATION BY EXTERNAL DEVICE” as a specific example of the mask screen 21. In contrast, the operation screen 20 is not hidden on the remote terminal 30 illustrated in FIG. 6B, thus the image processing apparatus 10 is operated only by the first user.

When the operation screen 20 of the image processing apparatus 10 is set in the hidden state by the mask screen 21 due to remote control, if an event to be notified to the second user occurs, a message indicating the occurrence of the event is displayed on each of the image processing apparatus 10 and the remote terminal 30. For example, when so-called “OUT OF PAPER” occurs as an example of an event to be notified to the second user, as illustrated in FIGS. 6A and 6B, the mask screen 21 is set to non-display, and a screen 22 showing out of paper is shared by the image processing apparatus 10 and the remote terminal 30. Specifically, the mask screen 21 is set to non-display in the image processing apparatus 10, and the screen 22 is displayed so as to be visible to the second user.

FIGS. 7A and 7B are views illustrating specific examples of information displayed on the image processing apparatus 10 and the remote terminal 30 when restrictions on the operation to the operation screen of the image processing apparatus 10 are released. FIG. 7A is a view illustrating a specific example of information displayed on the image processing apparatus 10 when restrictions on the operation to the operation screen of the image processing apparatus 10 are released. FIG. 7B is a view illustrating a specific example of information displayed on the screen of the remote terminal 30 when restrictions on the operation to the image processing apparatus 10 are released.

When the operation screen 20 of the image processing apparatus 10 is hidden, and restrictions are imposed on direct operation to the operation screen 20, an event to be notified to the second user may occur, and the event may require an operation of the second user to the operation screen. In this case, part or all of the restrictions is released so that the second user can operate the operation screen.

For example, when so-called “OUT OF PAPER” occurs as an example of an event to be notified to the second user, the hidden state of the operation screen is released, and part or all of the restrictions on the operation to the operation screen is released. Specifically, as illustrated in FIGS. 7A and 7B, when the operation screen 20 shared by each of the image processing apparatus 10 and the remote terminal 30 is changed to the screen 22, part or all of the restrictions on the operation to the image processing apparatus 10 is released. Consequently, in a range where restrictions are released, the screen 22 is operable via both the image processing apparatus 10 and the remote terminal 30, and the operation of the screen 22 by the second user is made possible. Subsequently, depending on the event which has occurred in the image processing apparatus 10, the image processing apparatus 10 is restarted.

FIG. 8 is a view illustrating a specific example of information displayed on the operation screen in a hidden state.

The operation screen of the image processing apparatus 10 remote controlled by the remote terminal 30 is hidden by the mask screen 21, thus is in a state where an operation by the second user cannot be received. In such a state of the operation screen, when an event to be notified to the second user occurs and the event requires restart of the image processing apparatus 10, the mask screen 21 is set to non-display, and part or all of the restrictions on the operation is released.

In contrast, depending on the event, the event to be notified to the second user may not require restart of the image processing apparatus 10, but is considered to have a certain significance in notifying the second user of the event. For such an event, a message indicating the contents of the event to be notified to the second user is displayed while the mask screen 21 is being displayed. Here, the “event considered to have a certain significance in notifying the second user of the event”, for example, is a case where the remaining amount of consumables, such as a toner cartridge and staple needles, is low. FIG. 8 illustrates an example in which the remaining amount of a toner cartridge is low, and a message 211 is displayed which indicates that it is recommended that a spare toner cartridge be prepared.

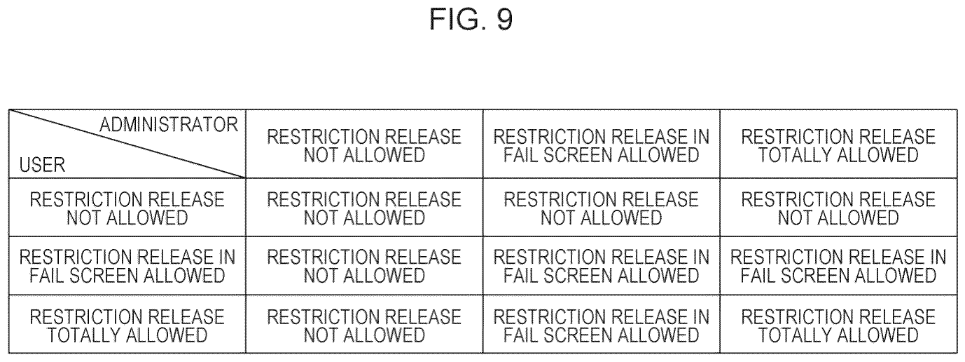

FIG. 9 is a table illustrating a specific example of setting release ranges when there is a plurality of users who specify the release ranges for restrictions on the operation.

As described above, when a single user specifies a release range for restrictions on the operation to the operation screen, the specified release range is set as the actual release range. In contrast, when a plurality of users specify release ranges, the narrowest one among the specified release ranges is set as the actual release range.

For example, as illustrated in FIG. 9, depending on the type of the event, the release range specified by each of the administrator (referred to as the “administrator” in FIG. 9) of the image processing apparatus 10 and the first user (referred to as the “user” in FIG. 9) is assumed to have three types: “RESTRICTION RELEASE NOT ALLOWED”, “RESTRICTION RELEASE IN FAIL SCREEN ALLOWED”, and “RESTRICTION RELEASE TOTALLY ALLOWED”. Here, the “RESTRICTION RELEASE” refers to releasing restrictions on the operation of the second user, and the “FAIL SCREEN” refers to the operation screen in which an event to be notified to the second user has occurred.

In this case, when each of the administrator and the first user specifies a release range as “RESTRICTION RELEASE NOT ALLOWED”, the actual release range is the type of “RESTRICTION RELEASE NOT ALLOWED”. When each of the administrator and the first user specifies a release range as “RESTRICTION RELEASE IN FAIL SCREEN ALLOWED”, the actual release range is the type of “RESTRICTION RELEASE IN FAIL SCREEN ALLOWED”. When each of the administrator and the first user specifies a release range as “RESTRICTION RELEASE TOTALLY ALLOWED”, the actual release range is the type of “RESTRICTION RELEASE TOTALLY ALLOWED”.

When one of the administrator and the first user specifies a release range as “RESTRICTION RELEASE NOT ALLOWED”, and the other specifies a release range as “RESTRICTION RELEASE IN FAIL SCREEN ALLOWED”, the actual release range is the narrower range of the type “RESTRICTION RELEASE NOT ALLOWED”. When one of the administrator and the first user specifies a release range as “RESTRICTION RELEASE NOT ALLOWED”, and the other specifies a release range as “RESTRICTION RELEASE TOTALLY ALLOWED”, the actual release range is the narrower range of the type “RESTRICTION RELEASE NOT ALLOWED”. When one of the administrator and the first user specifies a release range as “RESTRICTION RELEASE IN FAIL SCREEN ALLOWED”, and the other specifies a release range as “RESTRICTION RELEASE TOTALLY ALLOWED”, the actual release range is the narrower range of the type “RESTRICTION RELEASE IN FAIL SCREEN ALLOWED”.

### Other Exemplary Embodiments

Although the present exemplary embodiment has been described above, the present disclosure is not limited to the aforementioned exemplary embodiment. The effects provided by the present disclosure are also not limited to those described in the aforementioned exemplary embodiment. For example, the configuration of the information processing system 1 illustrated in FIG. 1, and the hardware configuration of the image processing apparatus 10 illustrated in FIG. 2 are each just an example to achieve the object of the present disclosure, and are not particularly limited thereto. The functional configuration of the image processing apparatus 10 illustrated in FIG. 3, and the functional configuration of the remote terminal 30 illustrated in FIG. 4 are just an example, and are not particularly limited thereto. It is sufficient that the information processing system 1 of FIG. 1 be provided with the function that can perform the above-described processes as the entire system, and in order to implement the function, the functional configuration to be used is not limited to the example in FIGS. 3 and 4.

The order of process steps of the image processing apparatus 10 illustrated in FIGS. 5A and 5B is just an example, and is not particularly limited thereto. The processes may be performed not only in time series in the order of illustrated steps, but also concurrently or individually without processing the processes in time series. The specific examples illustrated in FIGS. 6A and 6B to FIG. 9 are just an example, and is not particularly limited thereto.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or a plurality of processors configured to:
   upon a determination that an event which has occurred in an image processing apparatus with an operation screen in a hidden state due to remote control is to be notified to a second user to whom the operation screen is visible, display, on the operation screen, notification information including a message indicating that the event has occurred, the remote control being in operation via a terminal by a first user.
      (((2)))

The information processing system according to (((1))),
wherein the one or a plurality of processors are configured to, upon displaying the notification information on the operation screen, release the hidden state.
   (((3)))

The information processing system according to (((2))),
wherein the one or a plurality of processors are configured to, upon a determination that the event to be notified to the second user requires restart of the image processing apparatus, release the hidden state before the image processing apparatus is restarted.
   (((4)))

The information processing system according to (((2))),
wherein the one or a plurality of processors are configured to, upon a determination that restrictions are imposed on operation to the operation screen when the hidden state is released, release part or all of the restrictions.
   (((5)))

The information processing system according to (((4))),
wherein a range of the restrictions, which are to be released is determined based on a result of comparison between a range specified by an administrator of the image processing apparatus and a range specified by the first user.
   (((6)))

The information processing system according to (((4))) or (((5))),
wherein a narrower one between the range specified by the administrator of the image processing apparatus and the range specified by the first user is determined as the range of the restrictions to be released.
   (((7)))

The information processing system according to (((4))),
wherein a range of the restrictions to be released is determined for a type of the event based on contents of operation to be performed by the second user to resolve the event.
   (((8)))

The information processing system according to any one of (((2))) to (((7))),
wherein the one or a plurality of processors are configured to set the operation screen with the hidden state released to the hidden state again at a predetermined timing.
   (((9)))

The information processing system according to (((8))),
wherein the timing is one of a timing when the event is resolved, a timing when an operation to hide the notification information is performed, or a timing when a predetermined operation to the operation screen is performed.
   (((10)))

A program causing a computer to execute a process comprising
upon a determination that an event which has occurred in an image processing apparatus with an operation screen in a hidden state due to remote control is to be notified to a second user to whom the operation screen is visible, displaying, on the operation screen, notification information including a message indicating that the event has occurred, the remote control being in operation via a terminal by a first user.

What is claimed is:

1. An information processing system comprising:
one or a plurality of processors configured to:
upon a determination that an event which has occurred in an image processing apparatus with an operation screen in a hidden state due to remote control is to be notified to a second user to whom the operation screen is visible, display, on the operation screen, notification information including a message indicating that the event has occurred, the remote control being in operation via a terminal by a first user.

2. The information processing system according to claim 1,
wherein the one or a plurality of processors are configured to, upon displaying the notification information on the operation screen, release the hidden state.

3. The information processing system according to claim 2,
wherein the one or a plurality of processors are configured to, upon a determination that the event to be notified to the second user requires restart of the image processing apparatus, release the hidden state before the image processing apparatus is restarted.

4. The information processing system according to claim 2,
wherein the one or a plurality of processors are configured to, upon a determination that restrictions are imposed on operation to the operation screen when the hidden state is released, release part or all of the restrictions.

5. The information processing system according to claim 4,
wherein a range of the restrictions, which are to be released is determined based on a result of comparison between a range specified by an administrator of the image processing apparatus and a range specified by the first user.

6. The information processing system according to claim 5,
wherein a narrower one between the range specified by the administrator of the image processing apparatus and the range specified by the first user is determined as the range of the restrictions to be released.

7. The information processing system according to claim 4,
wherein a range of the restrictions to be released is determined for a type of the event based on contents of operation to be performed by the second user to resolve the event.

8. The information processing system according to claim 2,
wherein the one or a plurality of processors are configured to set the operation screen with the hidden state released to the hidden state again at a predetermined timing.

9. The information processing system according to claim 8,
wherein the timing is one of a timing when the event is resolved, a timing when an operation to hide the notification information is performed, or a timing when a predetermined operation to the operation screen is performed.

10. A non-transitory computer readable medium storing a program causing a computer to execute a process comprising
upon a determination that an event which has occurred in an image processing apparatus with an operation screen in a hidden state due to remote control is to be notified to a second user to whom the operation screen is visible, displaying, on the operation screen, notification information including a message indicating that the event has occurred, the remote control being in operation via a terminal by a first user.

11. An information processing method comprising
upon a determination that an event which has occurred in an image processing apparatus with an operation screen in a hidden state due to remote control is to be notified to a second user to whom the operation screen is visible, displaying, on the operation screen, notification information including a message indicating that the event has occurred, the remote control being in operation via a terminal by a first user.
